(19) United States
(12) Patent Application Publication
(10) Pub. No.: US 2022/0027930 A1
(43) Pub. Date: Jan. 27, 2022

(54) METHOD OF DIAGNOSING AND PREDICTING SCIENCE TECHNOLOGY POWER OF EACH COMPANY OR EACH COUNTRY USING PATENT DATA AND RESEARCH PAPER DATA

(71) Applicant: Jonghak OH, Seoul (KR)

(72) Inventor: Jonghak OH, Seoul (KR)

(21) Appl. No.: 17/311,221

(22) PCT Filed: Dec. 10, 2019
(86) PCT No.: PCT/KR2019/017366

§ 371 Date: Jun. 4, 2021

(30) Foreign Application Priority Data
Dec. 12, 2018 (KR) 10-2018-0160148

(51) Int. Cl. G06Q 30/02; G06Q 50/18; G06N 20/00

(52) U.S. Cl. CPC G06Q 30/0205; G06N 20/00; G06Q 30/0201; G06Q 50/184

(57) ABSTRACT

The present invention relates to a method for diagnosing and predicting the science technology power of countries, companies, research institutes, and desired technologies through a diagnosis model created by applying one or more patent and paper variables to a machine learning algorithm. The present invention comprises a step for: collecting patent or paper data for a predetermined technology, classifying the collected patent data into each country, company, and research institute, calculating one or more patent or paper variables, generating a diagnosis model by applying the variable to a machine learning algorithm, and calculating one or more diagnosis values using the diagnosis model.

### TECHNICAL FIELD

The present invention relates to a method of diagnosing and predicting the science technology power of each country and company using patent data and research paper (referred to as “paper” hereinafter) data. More specifically, the present invention relates to a method of diagnosing and predicting the science technology power of each country and company by calculating one or more patent variables and paper variables from patent data and paper data which contain science and technology information and then applying the patent variables and/or paper variables to machine learning algorithms.

### BACKGROUND ART

Most countries, and world-wide companies and research institutes are putting their R&D budgets in line with the economic situation thereof and making efforts to maximize the efficiency of the input budget. R&D budget allocation is an important factor in establishing an R&D strategy. Moreover, it is very important to establish the R&D strategy by diagnosing and predicting the technological strengths and weaknesses of competing countries or competing companies.

However, it is, in fact, difficult to diagnose and predict the strengths and weaknesses of respective countries or companies' R&D technologies.

Conventionally, the R&D strategy of each country or company has relied on the opinions of experts, which, however, has limitations in diagnosing and predicting the technological capabilities of numerous competing countries or competing companies. In addition, the changes in diagnosis and prediction results, which are different for each expert group, was an important factor that lowered the reliability of the diagnosis and prediction. In other words, it was difficult to secure reliability and objectivity in diagnosis and prediction results of competing countries or competing companies by experts.

Recently, with the spread of the digital economy, a big data environment in which a lot of information and data are produced is coming to an unpredictable scale. In addition, most countries and companies are increasingly using data in decision making. Academia, research institutes, and companies around the world produce huge amounts of patents and thesis data every year as a product of research and development (R&D).

Therefore, the present invention proposes a method for objectively diagnosing and predicting the technological strengths and weaknesses of respective countries and companies by using patent data and paper data.

### DISCLOSURE OF INVENTION

### Technical Problem

An object of the present invention is to diagnose a science technology power by applying patent and/or paper variables of each country or each company calculated from patent and/or paper data to a machine learning algorithm.

In addition, another object of the present invention is to predict a science technology power of each country or each company by calculating the patents and/or paper variables of each country or each company according to time-series information from patent and/or paper data, applying these patents and/or paper variables to a machine learning algorithm to calculate one or more diagnosis values of the science technology power of each country or company, and applying the diagnosis values to a time-series analysis algorithm.

### Technical Solution

To achieve the objects, according to one exemplary embodiment of the present invention, a method for diagnosing a science technology power of each country or company using patent data comprises: a step for collecting patent data of a predetermined technology from a patent database; a step for classifying the-collected patent data into each country or each company; a step for calculating patent variables from the classified patent data of each country or each company; a step for generating a patent diagnosis model to diagnose the science technology power of each country or each company by applying one or more patent variables to a machine learning algorithm; and a step for calculating patent diagnosis values to diagnose the science technology power of each country or each company using the patent diagnosis model.

In another exemplary embodiment of the present invention, a method for diagnosing a science technology power using paper data comprises: a step for collecting paper data of a predetermined technology from a paper database; a step for classifying the collected paper data by each country or each research institute; a step for calculating paper variables from the classified paper data of each country or each research institute; a step for generating a diagnosis model to diagnose the science technology power of each country or each research institute by applying one or more paper variables to a machine learning algorithm; and a step for calculating paper diagnosis values using the paper diagnosis model to diagnose the science technology power of each country or research institute.

In another exemplary embodiment of the present invention, a method for diagnosing a science technology power using both patent data and paper data comprises: a step for collecting patent data and paper data of a predetermined technology from a patent database and a paper database; a step for classifying the patent data and paper data by each country or each research institute; a step for calculating patent variables and paper variables from the classified patent data and paper data of each country or each research institute; a step for generating a patent and paper diagnosis model by applying the patent variables and paper variables to a machine learning algorithm; and a step for calculating patent and paper diagnosis values to diagnose the science technology power of each country using the patent and paper diagnosis model.

In another exemplary embodiment of the present invention, a method for predicting a science technology power using patent data comprises: a step for collecting patent data including time-series information for a predetermined technology from a patent database; a step for classifying the collected patent data by each country or each company according to the time-series information; a step for calculating patent variables from the classified patent data of each country or company according to the time-series information; a step for generating a patent diagnosis model to diagnose the science technology power of each country or company by applying the patent variables to a machine learning algorithm to; a step for calculating patent diagnosis values using the patent diagnosis model to diagnose the science technology power of each country or company according to the time-series information; and a step for calculating patent prediction values of the science technology power of each country or each company by applying the patent diagnosis values and the time-series information to a time-series algorithm.

In another exemplary embodiment of the present invention, a method for predicting a science technology power using paper data comprises: a step for collecting paper data including time-series information for a predetermined technology from a paper database; a step for classifying the collected paper data by each country or each research institute according to the time series information; a step for calculating paper variables from the classified paper data of each country or each research institute according to the time-series information; a step for generating a paper diagnosis model to diagnose the science technology power of each country or each research institute by applying one or more paper variables according to the time-series information to a machine learning algorithm and; a step for calculating paper diagnosis values using the paper diagnosis model to diagnose the science technology power of each country or research institute according to the time-series information; and a step for calculating paper prediction values of the science technology power of each country or each research institute by applying the paper diagnosis values and the time-series information to a time-series algorithm.

In another exemplary embodiment of the present invention, a method for predicting a science technology power using both patent data and paper data comprises: a step for collecting patent data and paper data including time-series information for a predetermined technology from a patent database and a paper database; a step for classifying the collected patent data and paper data by each country or each research institute according to the time-series information; a step for calculating patent variables and paper variables from the classified patent data and paper data of each country or each research institute according to the time-series information; a step generating a patent and paper diagnosis model to diagnose the science technology power of each country or each research institute by applying the patent variables and paper variables to a machine algorithm to; a step for calculating patent and paper diagnosis values using the patent and paper diagnosis model to diagnose the science technology power of each country or each research institute using the patent and paper diagnosis model; a step for calculating patent and paper prediction values of the science technology power of each country or each research institute by applying the paper and paper diagnosis values and the time-series information to a time-series algorithm.

### Advantageous Effects

The method for diagnosing a science technology power of one or more countries or companies according to one exemplary embodiment of the present invention calculates one or more patent variables and/or paper variables of each country or each company from the patent and/or paper data of a predetermined technology. It is possible to identify the strengths and weaknesses of each country or each company for a predetermined technology by diagnosing the technological power of each country or each company using a machine learning algorithm.

In addition, the method for predicting the science technology power for one or more countries or companies according to another exemplary embodiment of the present invention may objectively predict the science technology power of each country or each company by applying the diagnosis values to a time-series algorithm.

### DESCRIPTION OF DRAWINGS

The accompanied drawings, which are included as part of the detailed description to help to understand the present invention, provide the present invention's exemplary embodiment and describe the present invention's technical concept with the detailed description.

FIG. 1 is a block diagram showing a system for diagnosing and predicting science technology power using patent and/or paper data according to one exemplary embodiment of the present invention.

FIG. 2 is a flowchart showing a method for diagnosing science technology power using patent data according to another exemplary embodiment of the present invention.

FIG. 3 is a diagram illustrating one or more patent variables used as an input variable in generating a diagnosis model based on machine learning algorithm in the exemplary embodiment of FIG. 2.

FIG. 4 is a diagram illustrating the diagnosis result of the science technology power's strengths and weaknesses on countries or companies.

FIG. 5 is a flowchart illustrating a method for diagnosing science technology power using paper data according to another embodiment of the present invention.

FIG. 6 is a diagram illustrating one or more paper variables used as an input variable in a diagnosis model based on machine learning algorithm in the exemplary embodiment of FIG. 5.

FIG. 7 is a flowchart illustrating a method for diagnosing the science technology power using both patent data and paper data according to another embodiment of the present invention.

FIG. 8 is a diagram illustrating patent and paper variables used as input variable in generating a diagnosis model based on patent data and paper data through machine learning algorithm of another embodiment of FIG. 7.

FIG. 9 is a flowchart illustrating a method for predicting the science technology power using patent data according to another exemplary embodiment of the present invention.

FIG. 10 is a diagram illustrating input variables and target variables used in a time-series algorithm of the exemplary embodiment of FIG. 9.

FIG. 11 is a flowchart illustrating a method for predicting the science technology power using paper data according to another exemplary embodiment of the present invention.

FIG. 12 is a diagram illustrating input variables and target variables used in time-series prediction algorithm of the exemplary embodiment of FIG. 11.

FIG. 13 is a flowchart illustrating a method for predicting the science technology power using both patent data and paper data according to another exemplary embodiment of the present invention.

FIG. 14 is a diagram illustrating input variables and target variables used in time series prediction algorithm of the exemplary embodiment of FIG. 13.

### DETAILED DESCRIPTIONS FOR EMBODYING INVENTION

Hereinafter, exemplary embodiments of the present invention are described in detail with reference to the accompanying drawings.

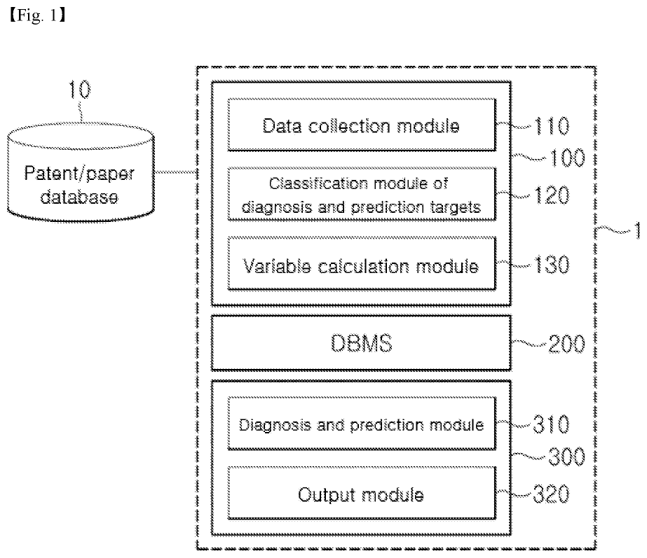

FIG. 1 is a block diagram showing a system for diagnosing and predicting the science technology power of one or more countries or companies using patent and/or paper data according to one exemplary embodiments of the present invention. Referring to FIG. 1, the system 1 for diagnosing and predicting the science technology power may include a data preprocessor 100, a DBMS 200, and the science technology diagnosis/prediction unit 300. Here, the data preprocessor 100 may include a data collection module 110, a diagnosis/prediction target classification module 120, and a variable calculation module 130. The science technology diagnosis/prediction unit 300 may include a diagnosis/prediction module 310 and an output module 320. The data collection module 110 may collect patent and/or paper data for a given science technology from the patent/paper database 10. The data collection module 110 may collect patent and/or paper data for each predetermined arbitrary interval or collect patent and/or paper data at the request of an operator. The data collection module 110 may comprehensively collect patent and/or paper data for a given science technology from the patent/paper database 10 or partially collect patent and/or paper data according to predetermined criteria set by an operator or user. The diagnosis/prediction target classification module 120 may classify the diagnosis/prediction target (ex. company, country, research institute or technology) according to time (ex. Year, month, half-year, quarter, etc.), based on the patent and/or paper data information.

The variable calculation module 130 may extract and calculate patent and/or paper variables by each time from the patent and/or paper data. For example, the patent and/or paper variable may include the number of papers, the number of paper citation, the number of patent applications, the number of patent citation, the number of patent family countries, the number of triode patents, the number of US registered patents and so on. In addition, the patent and/or paper variables may include a patent AI (Activity Index) index, a patent II (Intensity Index) index, a patent MI (Market Index) index, a patent CI (Citation Index) index, a paper AI (Activity Index) index, a paper II (Intensity Index) index, a paper CI (Citation Index) index etc. The patent and/or paper variables may be calculated for each company, country, research institute or technology.

The patent and/or paper variables may be stored in a DBMS (Database Management System, 200) for each company, country, research institute or a desired technology.

The diagnosis/prediction module 310 may generate a diagnosis model for each country, company, research institute or desired technology over time by applying patent and/or paper variables stored in the DBMS 200 as input variable to the machine learning algorithm. For example, the diagnosis model may be generated for a given science technology (ex. AI) each year from 2000 to 2018, based on countries, companies, research institutes. A diagnosis value may be calculated, based on such diagnosis model. The diagnosis values may be stored in the DBMS 200 as well.

The output module 320 may display diagnosis values of one or more countries, companies, research institutes or desired technology to a user. Here, the countries are defined as countries all around the world including US, China, Japan, Germany, Korea. The companies are defined as global, small, and medium-sized companies such as Amazon, Facebook, Google, Samsung Electronics, LG Electronics and so on. Also, the desired technologies are defined broadly or narrowly, including artificial intelligence, IOT, autonomous robots, etc. In addition, the science technology power refers to the technical strengths and weaknesses of countries, companies, and research institutes.

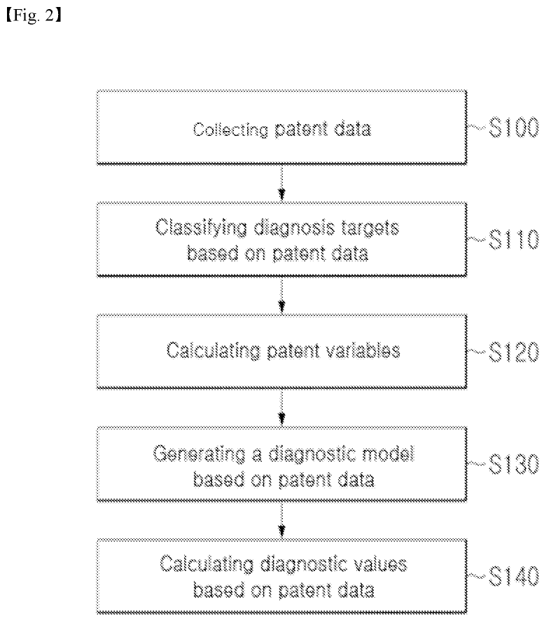

FIG. 2 is a flowchart illustrating a method for diagnosing the science technology power of countries, companies or desired technologies using patent data according to an exemplary embodiment of the present invention. Referring to FIG. 2, the method for diagnosing the science technology power using patent data may include a patent data collection step S100, a patent-based diagnosis target classification step S110, a patent variable calculation step S120, a patent-based diagnosis model generation step S130 and a patent-based diagnosis value calculation step S140. The patent data collection step S100 may be a step for collecting patent data of a predetermined technology from internal and external patent databases using keywords, international patent classification, and so on.

The patent database stores patent data applied to patent offices of each country. The bibliographic information of the patent data includes the name of the invention, the applicant (including the assignee, hereinafter the same), the patentee (including the assignee, hereinafter the same), the inventor, the patent classification code, the filing date, the priority filing country, the priority date, the application number, citation information, family application countries, etc.

The diagnosis and prediction system 1 may collect patent data from the patent database to calculate one or more patent variables. The diagnosis and prediction system 1 may collect patent data at predetermined arbitrary intervals or may collect patent data at the request of an operator. In addition, the diagnosis and prediction system 1 may collect patent data of a given science technology set by a user or an operator. In the diagnosis target classification step S110, the patent data collected in the patent data collection step S100 may be classified based on countries or companies, which are the target of science technology power diagnosis.

Here, the companies may mean information on an applicant or a patentee included in the bibliographic information of the patent data. The countries may mean nationality information of the applicant or patentee. In addition, the countries may mean countries where the patent office is located, to which the applicant or patentee has applied. Moreover, patent data may be subdivided and classified by each technology.

The technology may have a hierarchical structure such as a large classification, a medium classification, and a small classification. For example, the science technology may be classified into a plurality of large classifications, which are higher classification systems, also, each large classification may be classified into a plurality of medium classifications, which are lower classification system. At this time, each medium classification may be classified as small classifications, which are lower classification system.

The patent variable calculation step S120 may calculate one or more patent variables from patent data classified by country or company.

In more detail, the diagnosis and prediction system 1 may calculate one or more patent variables from patent data classified by a plurality of countries or companies through the diagnosis target classification step S110. Here, the patent variables may include at least one or more among the number of patent applications, the number of patent citations, the number of cited patents, the number of patent family countries, the number of triode patents, and the number of US registered patents. Further, the patent variables may be calculated by a given equation consisting of at least one or more among the number of patent applications, the number of patent citations, the number of cited patents, the number of family patents, the number of triode patents, and the number of US registered patents. The following equations are exemplary and various equations may be presented according to the purpose of the present, without being limited to the equations presented below.

Here, a given equation may be an AI (Activity Index) index, II (Intensity Index) index, MI (Market Index) index and CI (Citation Index) index.

1. Patent AI Index (Activity Index)

$${AI}_{ij} = \frac{{P}_{ij}}{{\sum }_{j = 1}^{nt} {P}_{ij}} \qquad [ Equation 1 ]$$

The patent AI index is a quantitatively measurable variable calculated, based on the number of the patent applications. Here, Pᵢⱼ means the number of patent applications for predetermined technology i of countries or companies j, and nt means the total number of countries and companies.

2. Patent II Index (Intensity Index)

$${II}_{ij} = \frac{( {P}_{ij} / {\sum }_{j = 1}^{nt} {P}_{ij} )}{( {\sum }_{i = 1}^{mt} {P}_{ij} / {\sum }_{i = 1}^{mt} {\sum }_{j = 1}^{nt} {P}_{ij} )} \qquad [ Equation 2 ]$$

The patent II index is a variable for calculating the degree to which applications are concentrated on a specific technology based on the number of the patent applications.

Here, Pᵢⱼ means the number of patent applications for the technology i of country or company j, nt means the total number of countries or companies, and mt means the total number of the technologies.

3. Patent MI Index (Market Index)

$${MI}_{ij} = \frac{( {FP}_{ij} / {P}_{ij} )}{( {\sum }_{j = 1}^{nt} {FP}_{ij} / {\sum }_{j = 1}^{nt} {P}_{ij} )} \qquad [ Equation 3 ]$$

The patent MI index is a variable for calculating market influence based on the number of the patent applications and the number of countries for which family patents are filed. Here, Pᵢⱼ means the number of patent applications for technology field i of the country or company j, nt means the total number of countries or companies, and FPᵢⱼ means the number of family patent countries of the country or company j for the predetermined technology i.

4. Patent CI Index (Citation Index)

$${CI}_{ij} = \frac{( {CP}_{ij} / {RP}_{ij} )}{( {\sum }_{j = 1}^{nt} {CP}_{ij} / {\sum }_{j = 1}^{nt} {RP}_{ij} )} \qquad [ Equation 4 ]$$

The patent CI index is a variable for calculating the impact on other countries or companies based on the number of the patent citations.

Here, CPᵢⱼ means the number of patent citations of company and country j for i technology, RPᵢⱼ means the number of registered patents of the company or country j for i technology, and nt means the total number of technologies.

These patent variables are stored in the DBMS 200.

The diagnosis model generation step S130 may generate a diagnosis model of the science technology power for countries or companies by learning one or more the patent variables through a machine learning algorithm.

The diagnosis model may be generated by a machine learning algorithm such as supervised regression or unsupervised learning.

Preferably, the machine learning algorithm may be performed by supervised learning such as linear regression and logistic regression model.

As an example, a diagnosis model generated by using logistic regression model may be expressed as shown in [Equation 5] below.

$$\frac{Prob ( Patent - Tech - Strength )}{1 - Prob ( Patent - Tech - Strength )} = e \text{?} \\ \text{?} \text{indicates text missing or illegible when filed} \qquad [ Equation 5 ]$$

Hear, Prob(Patent−Tech−Strength) is diagnosis values of the science technology power, in which X is the patent variables, and β is the weight.

The diagnosis values may calculate the diagnosis values Prob(Patent−Tech−Strength) using the diagnosis model of [Equation 5] S140.

Using the diagnosis values, it is possible to diagnose the science technology's strengths and weaknesses of each country or company.

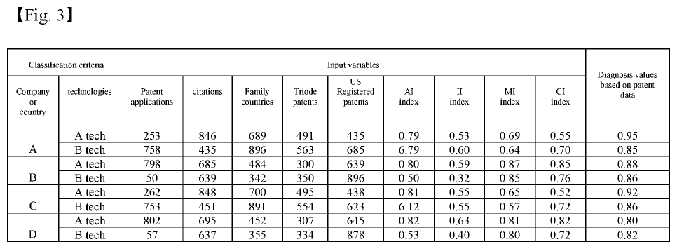

FIG. 3 is a diagram illustrating one or more patent variables used as input variables in generating a diagnosis model based on a machine learning algorithm in the exemplary embodiment of FIG. 2.

Referring to FIG. 3, the patent variables are exemplarily set values, the values being variously changed.

Specifically, the diagnosis and prediction system 1 may calculate patent variables such as the number of applications, the number of citations, the number of cited patents, the number of family countries, the number of triode patents, the number of US registered patents, patent AI index, patent II index, patent MI index, patent CI index from patent data. These patent variables may be utilized as input variables of machine learning in the diagnosis/prediction module 310. Referring to the table in FIG. 3 as an example, “A” country refers to the “A” technology. As patent variables, “A” country may have 253 applications, 846 citations, 689 cited patents, 491 family countries, 435 triodes patents, and 454 US registered patents. In addition, “A” country may calculate the patent AI index of 0.79, the patent II of 0.53, the patent MI index of 0.69, the patent CI index of 0.55 as patent variables for “A” technology. The patent variables are learned as input variables of the machine learning in the diagnosis/prediction module 310. As a result of the machine learning, the diagnosis model of [Equation 5] is generated. With this diagnosis model, the “A” country has the diagnosis value of 0.95 for the “A” technology. The closer to 1 the diagnosis value of the country or company indicates a higher science and technology power. Conversely, the closer to 0, the lower science and technology power is.

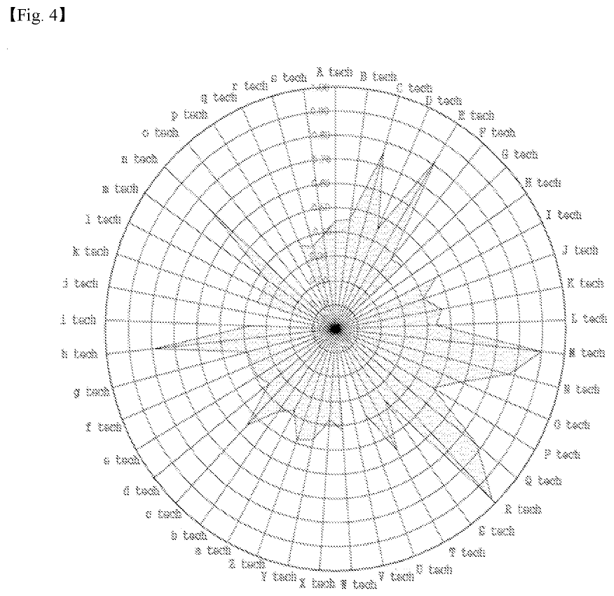

FIG. 4 is a diagram illustrating the diagnosis result of strengths and weaknesses in the science technology power of each country or company for predetermined technologies. FIG. 4 illustrates a radial graph showing the science technology power of each country or a company. But the science technology power may be expressed in various types of graphs.

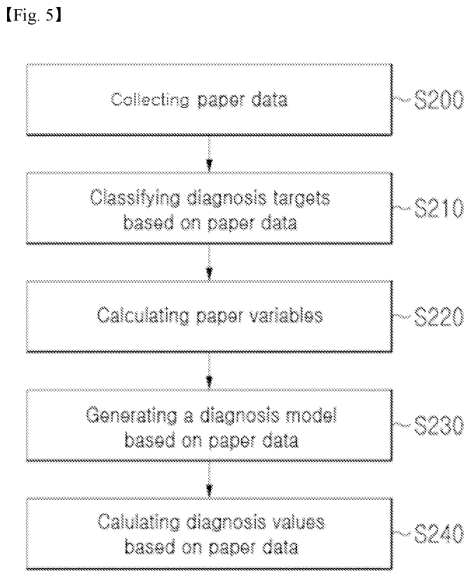

FIG. 5 is a flowchart illustrating a method of diagnosing the science technology power using paper data according to another exemplary embodiment of the present invention.

Referring to FIG. 5, a method of diagnosing the science technology power using paper data may include paper data collection step S200, a diagnosis target classification step S210, a variable calculation step S220, and a diagnosis model generation step S230, and a diagnosis value calculation step S240.

The paper data collection step S200 may collect paper data of a predetermined technology from an internal and external paper database.

The paper data includes information on the paper author, the nationality of paper author, the name of the research institution, the name of the paper, the publication date, the journal abstract, citation and so on. The diagnosis and prediction system 1 may continuously collect paper data from the paper database to calculate one or more paper variables.

The diagnosis target classification step S210 may classify the paper data according to a country, a research institute, or an industry technology.

Here, the country may be defined as the nationality of the paper author. The research institute may be defined as the author's research institute.

The paper variable calculation step S220 may extract and calculate one or more paper variables from paper data classified by the country or research institute.

In more detail, the diagnosis and prediction system 1 may calculate paper variables from paper data classified by a plurality of countries and research institutes. Here, the paper variables may include information on at least one or more the number of papers and the number of cited papers. Furthermore, the paper variables may be calculated by a given equation consisting of at least one or more among the number of papers and the number of cited papers. These equations are not limited to the equations below and may be made in various ways.

Here, the given equation may be paper AI index, paper II index and paper CI index. These indices may be calculated as follows.

1. Paper AI Index (Activity Index)

$${AI}_{ij} = \frac{{T}_{ij}}{{\sum }_{j = 1}^{nt} {T}_{ij}} \qquad [ Equation 6 ]$$

The paper AI index is a quantitative measurement variable based on the number of papers.

Here, Tᵢⱼ is the number of papers on the technology i of the country or research institute j, and nt is the number of the total number of countries or research institutes.

2. Paper II Index (Intensity Index)

$${II}_{ij} = \frac{( {T}_{ij} / {\sum }_{j = 1}^{nt} {T}_{ij} )}{( {\sum }_{i = 1}^{mt} {T}_{ij} / {\sum }_{i = 1}^{mt} {\sum }_{j = 1}^{nt} {T}_{ij} )} \qquad [ Equation 7 ]$$

Paper II index is used to calculate the degree to which paper publication is concentrated on a desired technology based on the number of the papers.

Here, Tᵢⱼ is the number of papers on the technology i of the country or research institute j, nt is the number of all countries or research institutes, and mt is the total number of the technologies.

3. Paper CI Index (Citation Index)

$${CI}_{ij} = \frac{{CT}_{ij}}{{\sum }_{j = 1}^{nt} {CT}_{ij}} \qquad [ Equation 4 ]$$

The paper CI index is used to calculate the influence impact on other countries based on the number of citations in the paper data.

Here, CTᵢⱼ is the number of paper citations of the country or research institute j on i technology, and nt is the total number of countries or research institutes.

The diagnosis model generation step S230 may learn one or more the paper variables through a machine learning algorithm to generate a diagnosis model of the science technology power for countries or research institutes.

The machine learning algorithm may be performed by a supervised learning or a unsupervised learning. In more detail, the machine learning algorithm may be performed using logistic regression model.

As an example, the diagnosis model can be expressed as [Equation 9] below.

$$\frac{Prob ( Paper - Tech - Strength )}{1 - Prob ( Paper - Tech - Strength )} = e \text{?} \\ \text{?} \text{indicates text missing or illegible when filed} \qquad [ Equation 9 ]$$

Hear, Prob(Paper−Tech−Strength) is a diagnosis value of the science technology power, in which X is the paper variables and β is the weight.

The diagnosis value calculation step S240 may calculate the diagnosis value Prob(Paper−Tech−Strength) using the diagnosis model of [Equation 9]. Using these diagnosis values, it is possible to diagnose the strengths and weaknesses of countries or research institutes for the scientific technology.

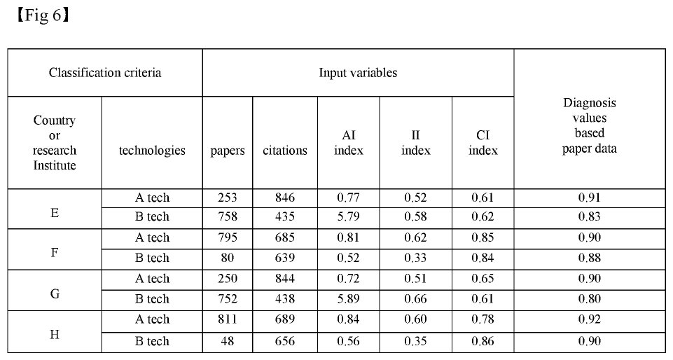

FIG. 6 is a diagram illustrating input variables used when generating the diagnosis model of [Equation 9]

FIG. 6 exemplifies paper variables for the technology (i.e., A, B) of countries or research institutes such as “E”, “F”, “G”, and “H”.

The diagnosis and prediction system 1 of FIG. 1 may calculate paper variables such as the number of papers, the number of citations, paper AI index, paper II index, and paper CI index.

For example, “E” country may have 253 papers and 846 citations as paper variables for B technology. In addition, for “E” country, the paper AI index of 0.77, the paper II index of 0.52, and the paper CI index of 0.61 may be calculated for technology A.

These paper variables may be learned as input variables of a machine learning algorithm in the diagnosis/prediction module 310. As a result of the machine learning, a diagnosis model of [Equation 9] is generated, and a diagnosis value of 0.91 for “A” technology of “E” country is calculated through the diagnose model.

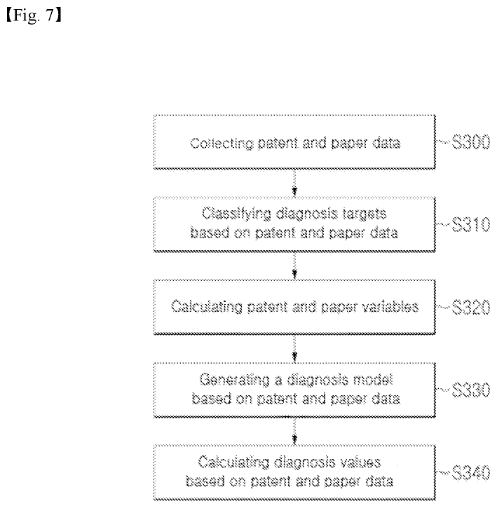

FIG. 7 is a flowchart illustrating a method for diagnosing the science technology power of each country or each technology using both patent data and paper data according to another embodiment of the present invention.

Referring to FIG. 7, the method may collect a patent data and a paper data S300, classify a diagnosis target S310, and calculate patent variables and paper variables S320, generate a diagnosis model based on the patent and paper variables S330, and calculate diagnosis values based on the diagnosis model 340.

In step S300, the patent data and paper data may be collected from internal and external patent databases and paper databases,

In the step S310, the patent data and paper data may be classified into each country.

In the step 320, the patent variables and the paper variables may be calculated by the patent data and paper data for each country.

Here, the patent variables may include at least one or more among the number of patent applications, the number of patent citations, the number of cited patents, the number of family countries, the number of triode patents, and the number of US registered patents. The paper variables may include the number of papers and the number of cited papers.

Furthermore, the patent variables may further include at least one or more among a patent AI index, a patent II index, a patent MI index, and a patent CI index. The paper variable may further include at least one or more among the paper AI index, the paper II index, and the paper CI index.

In the step S330, the diagnosis model may be generated by applying one or more among paper variables and paper variables to a machine learning algorithm.

As an example, the diagnosis model may be expressed as [Equation 10] below using the logistic regression model.

$$\frac{Prob ( Patent - Paper - Tech - Strength )}{1 - Prob ( Patent - Paper - Tech - Strength )} = e \text{?} \\ \text{?} \text{indicates text missing or illegible when filed} \qquad [ Equation 10 ]$$

Here, Prob(Patent−Paper−Tech−Strength) is the patent and paper-based diagnosis value of science technology power, X is the patent variables and paper variables, and β is the weight of the patent variables and paper variables.

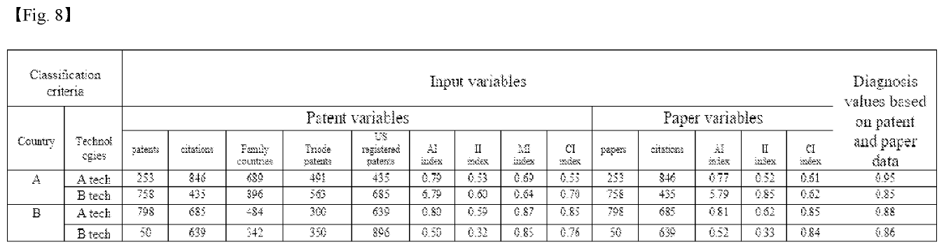

FIG. 8 is a diagram for illustrating input variables used in the diagnosis model of [Equation 10].

Referring to FIG. 8, the values of the patent variables and paper variables of each country are shown. One or more among these patent variables and paper variables may be input as input variables required for a machine learning algorithm.

In FIG. 8, the patent variables and paper variables are exemplified as input variables for the technology “A” of the country “A”. Country “A” is a patent variable for technology “A”, and may have 253 applications, 846 citations, 689 family countries, 491 triode patents, and 435 US registered patents. In addition, the “A” country may have a patent AI index of 0.79, a patent II index of 0.53, a patent MI index of 0.69, and a patent CI index of 0.55. In addition, the “A” country may have 253 papers, 846 citations, and the paper AI index of 0.77, the paper II index of 0.52, the paper CI index of 0.61 as the paper variable for “A” technology. These patent variables and paper variables are learned in the diagnosis/prediction module 310 of FIG. 1. As a result of the learning, the diagnosis model of [Equation 10] is generated and a diagnosis value based on a patent of 0.95 for the “A” technology of the “A” country may be calculated using the diagnosis model.

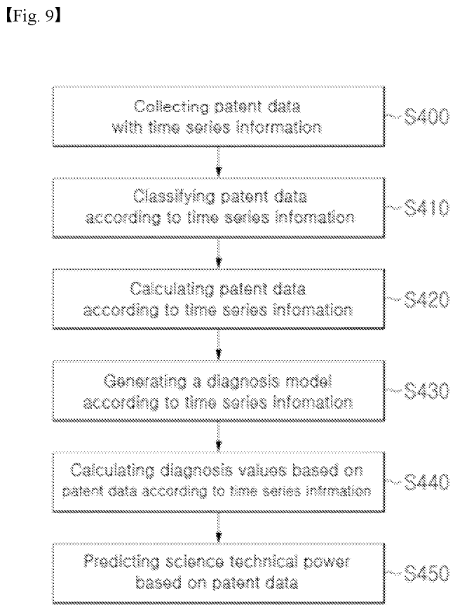

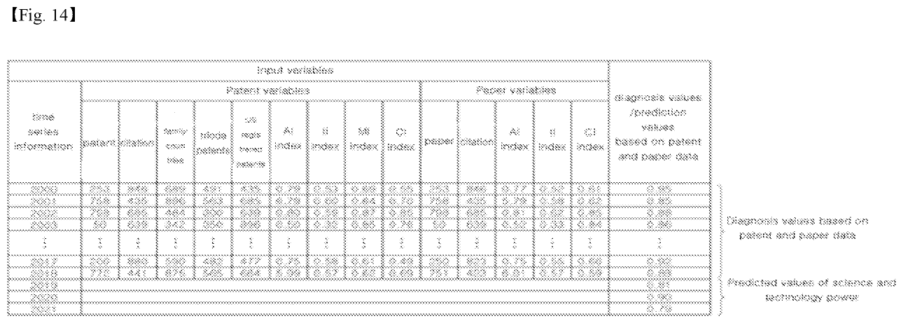

Hereinafter, FIG. 9 or FIG. 14 will describe for a method of predicting the science technology power of each country, a research institute, or an industry technology by using one or more among patent data and paper data according to another exemplary embodiment of the present invention.

FIG. 9 is a flowchart illustrating a method of predicting the science technology power using patent data according to another exemplary embodiment of the present invention.

Unlike the method for diagnosing the science technology power using the patent data of FIG. 2, in FIG. 9, the patent data collected for a desired technology will be classified into each country or company according to time series information (ex. Year, month, quarter).

Referring to FIG. 9, the method of predicting the science technology power using patent data may collect a patent data S400, classify a patent data according to time series information S410, calculate one or more patent variables according to time series information S420, a generate a diagnosis model S430, calculate one or more diagnosis values (S440), and predicting a science technology power prediction based on the diagnosis values according to time series information S450.

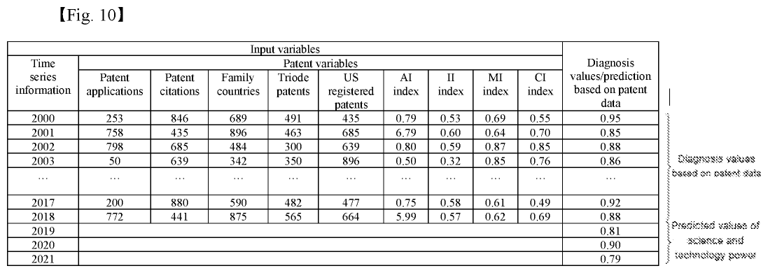

FIG. 10 is a diagram illustrating input variables and target variables used in time-series algorithm of the exemplary embodiment of FIG. 9.

Referring to FIG. 10, the diagnosis/prediction module 310 calculates diagnosis values based on the patent data every year according to time information (ie, 2000 to 2018). The diagnosis values are learned through the time-series algorithm to obtain one or more prediction values. Specifically, in FIG. 10, it may be shown that patent-based diagnosis values from 2000 to 2018 are calculated by arbitrary country or company for a certain technology. The diagnosis/prediction module 310 may learn such a patent-based diagnosis value through a time series prediction algorithm to calculate a patent-based predicted value from 2019 to 2021, which is a future point in time. Here, an artificial intelligence neural network, Deep AR and so on may be used for the time series prediction algorithm. In addition, an exponential smoothing method, a moving average method, and an auto-regressive integrated moving average (ARIMA) model may be used as a time series prediction method.

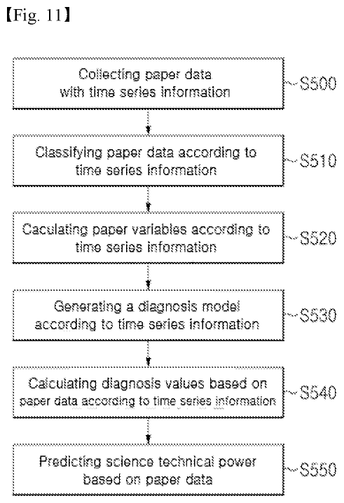

FIG. 11 is a flowchart illustrating a method of predicting the science technology power using paper data according to another embodiment of the present invention.

Referring to FIG. 11, the method of predicting the science technology power using paper data may collect a paper data including time-series information S500, classify a paper data according to time-series information S510, calculate paper variables according to time-series information S520, generate a diagnosis model according to the time series information S530, calculate one or more diagnosis values S540, and predict the science technology according to the time series information S550.

In the step S510, the paper data may be classified into each country, each research institute, and each technology.

The diagnosis/prediction module 310 may calculate paper variables from the paper data. In addition, the AI index, II index, and CI index may be calculated by arithmetic combination of the number of papers and the number of citations S520.

Thereafter, the diagnosis/prediction module 310 may generate a diagnosis model over time by learning the paper variables using a machine learning algorithm S530.

The diagnosis/prediction module 310 calculates one or more diagnosis values for diagnosing the science technology power of each country or research institute according to the time-series information using the diagnosis model S540.

The diagnosis values according to the time-series information may be learn through time series prediction algorithm to calculate the prediction values S550.

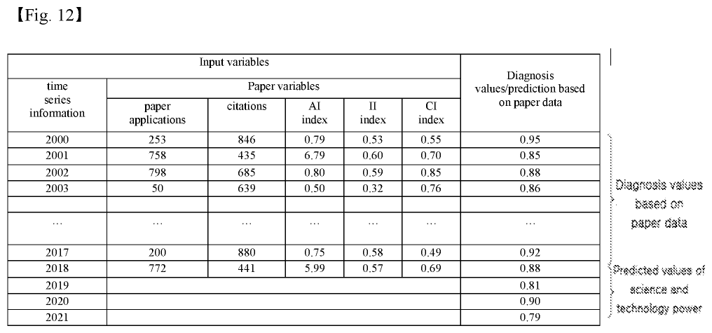

FIG. 12 is a diagram illustrating input variables and target variables used in time-series prediction algorithm of the exemplary embodiment of FIG. 11.

Referring to FIG. 12, the diagnosis/prediction module 310 calculates diagnosis values for each year according to time information (ie, 2000 to 2018). The diagnosis values are learned using a time-series prediction algorithm to calculate prediction values. Specifically, in FIG. 12, the diagnosis values from 2000 to 2018 were calculated by a certain country or research institute for a desired technology. The diagnosis/prediction module 310 may calculate the predicted values from 2019 to 2021. The time-series prediction method includes an exponential smoothing method, a moving average method, and an auto-regressive integrated moving average (ARIMA) model.

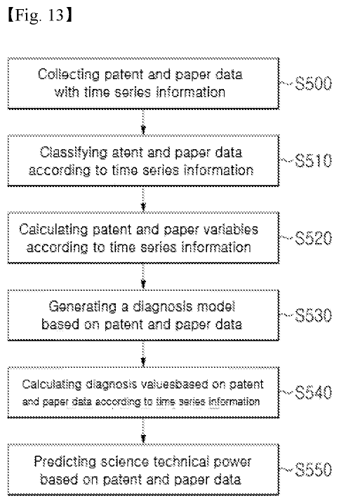

FIG. 13 is a flowchart illustrating a method of predicting the science technology power using both patent data and paper data according to another exemplary embodiment of the present invention.

FIG. 13 illustrates a method of predicting the science technology power of each country using both patent data and paper data.

Referring to FIG. 13, the method of predicting the science technology may collect the patent data and paper data from the patent/paper database 100 S600, classifying the patent data and paper data according to time-series information S610, calculating one or more patent and paper variables S620, generating a diagnosis model according to time-series information S630, calculating one or more diagnosis values S640, and predicting the science and technology power using the diagnosis values S650.

The diagnosis/prediction module 310 collects the patent data and paper data of a predetermined technology S600 and classifies the patent data and paper data according to time series information S610.

Thereafter, the diagnosis/prediction module 310 may calculate one or more patent variables and paper variables from the patent data and paper data. The patent variables and paper variables may include a patent AI index, patent II index, patent MI index, patent CI index, paper AI index, paper II index, and paper CI index S620.

Thereafter, the diagnosis/prediction module 310 may generate a diagnosis model by learning the patent variables and the paper variables through a machine learning algorithm S630.

The diagnosis/prediction module 310 calculates one or more diagnosis values for diagnosing the science technology power of each country according to the time series information by using the diagnosis model based on the patent data and paper data S640.

The patent and paper-based diagnosis values according to the time series information generated through the process may be learned through a time series prediction algorithm, and as a result, the patent and paper-based prediction values of a future point in time may be calculated (S650).

FIG. 14 is a diagram illustrating input variables and target variables used in time-series prediction algorithm of the exemplary embodiment of FIG. 13.

Referring to the FIG. 14, the diagnosis/prediction module 310 calculates the diagnosis values every year according to time information (that is, from 2000 to 2018). The diagnosis values are learned using the time-series prediction algorithm. Specifically, in FIG. 12, it may be shown that the diagnosis values from 2000 to 2018 were calculated by a certain country or research institute for a desired technology. The diagnosis/prediction module 310 may calculate the predicted values from 2019 to 2021 by learning the diagnosis values through the time series prediction algorithm. Here, an artificial intelligence neural network, Deep AR, etc. may be used for the time-series prediction algorithm. In addition, an exponential smoothing method, a moving average method, and an auto-regressive integrated moving average (ARIMA) model may be used as the time-series prediction method.

The description is merely illustrative of the technical idea of the present invention, and those having ordinary knowledge on the art to which the present invention pertains will be able to make various modifications and variations without departing from the essential characteristics of the present invention. Accordingly, the embodiments described in the present invention are not intended to limit the technical idea of the present invention, but to explain it, and are not limited to these embodiments. The scope of protection of the present invention should be construed by the following claims, and all technical ideas within the scope equivalent thereto should be construed as being included in the right scope of the present invention.

What is claimed is:

1. A method for diagnosing a science technology power using patent data, comprising:
collecting patent data of a predetermined technology from a patent database,
classifying the collected patent data by each country or each company,
calculating patent variables from the classified patent data of each country or each company,
generating a patent diagnosis model to diagnose the science technology power of each country or each company by applying one or more patent variables to a machine learning algorithm to,
calculating patent diagnosis values to diagnose the science technology power of each country or each company using the patent diagnosis model.

2. The method of claim 1, wherein the patent variables include one or more information on a number of patent applications, a number of patent citations, a number of cited patents, a number of family patent application countries, a number of triode patents, a number of US-registered patents, a patent AI (Activity Index) index, a patent II (Intensity Index) index, a patent MI (Market Index) index, and a patent CI (Citation Index) index.

3. The method of claim 2, wherein the patent AI index is a quantitative measurement variable calculated based on the number of patent applications,
the patent II index is a variable for calculating a degree to which patent applications are concentrated on a specific technology based on the number of patent applications,
the patent MI index is a variable for calculating a market influence based on the number of the patent applications and the number of the family patents,
the patent CI index is a variable for calculating an impact on other countries or companies based on the number of patent citations.

4. The method of claim 1, wherein the machine learning algorithm includes a supervised regression algorithm or an unsupervised learning algorithm.

5. The method of claim 4, wherein the machine learning algorithm uses a logistic regression model.

6. A method of diagnosing a science technology power using paper data, comprising:
collecting paper data of a predetermined technology from a paper database,
classifying the collected paper data by each country or each research institute,
calculating paper variables from the classified paper data of each country or research institute,
generating a paper diagnosis model to diagnose the science technology power of each country or each company by applying one or more paper variables to a machine learning algorithm, and
calculating paper diagnosis values to diagnose the science technology power of each country or each research institute using the paper diagnosis model.

7. The method of claim 6, wherein the paper variables include at least one of a number of papers, a number of paper citations, a number of cited papers, a paper AI (Activity Index) index, a paper II (Intensity Index) index, and a paper CI (Citation Index) index.

8. The method of claim 7, wherein the paper AI index is a quantitative measurement variable calculated based on the number of papers,
the paper II index is a variable for calculating a degree to which paper publications are concentrated on a specific technology based on the number of paper publications,
the paper CI index is a variable for calculating an impact on other countries based on the number of cited papers.

9. The method of claim 7, wherein the machine learning algorithm includes a supervised regression or unsupervised learning algorithm.

10. The method of claim 6, wherein the machine learning algorithm uses a logistic regression model.

11. A method for diagnosing a science technology power using both patent data and paper data, comprising:
collecting patent data and paper data of a predetermined technology from patent and paper databases,
classifying the collected patent data and paper data by each country or each research institute,
calculating patent and paper variables from the classified patent data and paper data of each country or each research institute,
generating a patent and paper diagnosis model to diagnose the science technology power of each country or each company by applying the patent and paper variables to a machine learning algorithm, and
calculating patent and paper diagnosis values to diagnose the science technology power of each country or each research institute using the patent and paper diagnosis model.

12. The method of claim 11, wherein the patent variables include one or more information on a number of patent applications, a number of citations, a number of cited patents, a number of family countries, a number of triode patents, a number of US-registered patents, a patent AI (Activity Index) index, a patent II (Intensity Index) index, a patent MI (Market Index) index, a patent CI (Citation Index) index, and
wherein the paper variables include one or more information on a number of papers, a number of paper citation, a number of cited papers, a paper AI (Activity Index) index, a paper II (Intensity Index), and a paper CI (Citation Index).

13. The method of claim 12, wherein the patent AI index is a quantitative measurement variable calculated based on the number of the patent applications, the patent II index is a variable for calculating a degree to which patent applications are concentrated on a specific technology based on the number of patent applications, the patent MI index is a variable for calculating a market influence based on the number of patent applications and the number of family countries, the patent CI index is a variable for calculating the impact on other countries or companies based on the number of patent citations, and
wherein the paper AI index is a quantitative measurement variable calculated based on the number of papers, the paper II index is a variable for calculating a degree to which paper publications are concentrated on a specific technology based on the number of papers, and the paper CI index is a variable for calculating an impact on other countries based on the number of paper citations.

14. The method of claim 11, wherein the machine learning algorithm includes a supervised regression learning or an unsupervised learning.

15. The method of claim 11, wherein the machine learning algorithm uses a logistic regression model.

16. A method for predicting a science technology power using patent data, comprising:
collecting patent data including time-series information for a predetermined technology from a patent database,
classifying the collected patent data by each country or each company according to the time series information,
calculating patent variables from the classified patent data of each country or company according to the time-series information,
generating a patent diagnosis model to diagnose the science technology power of each country or each company by applying the patent variables to a machine learning algorithm,
calculating patent diagnosis values using the patent diagnosis model for diagnosing the science technology power of each country or each company according to the time-series information, and
calculating patent prediction values of the science technology power of each country or each company by applying the patent diagnosis values and the time-series information to a time-series algorithm.

17. A method for predicting a science technology power using paper data, comprising:
collecting paper data including time-series information for a predetermined technology from a paper database,
classifying the collected paper data by each country or each research institute according to the time-series information,
calculating paper variables from the classified paper data of each country or each research institute according to the time-series information,
generating a paper diagnosis model to diagnose the science technology power of each country or each company by applying one or more paper variables according to the time-series information to a machine learning algorithm,
calculating paper diagnosis values using the paper diagnosis model for diagnosing the science technology power of each country or each research institute according to the time-series information, and
calculating paper prediction values of the science technology power of each country or each research institute by applying the paper diagnosis values and the time-series information to a time-series algorithm.

18. A method for predicting a science technology power using patent data and paper data, comprising:
collecting patent data and paper data including time-series information for a predetermined technology from patent and paper databases,
classifying the collected patent data and paper data by each country or each research institute according to the time-series information,
calculating patent and paper variables from the classified patent data and paper data of each country or each research institute according to the time-series information, generating a patent and paper diagnosis model to diagnose the science technology power of each country or each research institute by applying the patent and paper variables to a machine learning algorithm,
calculating patent and paper diagnosis values using the patent and paper diagnosis model for diagnosing the science technology power of each country or each research institute according to the time-series information, and
calculating patent and paper prediction values of the science technology power of each country or each research institute by applying the patent and paper diagnosis values and the time-series information to a time-series algorithm.
